(19) United States
(12) Patent Application Publication
(10) Pub. No.: US 2014/0099614 A1
(43) Pub. Date: Apr. 10, 2014

(54) METHOD FOR DELIVERING BEHAVIOR CHANGE DIRECTIVES TO A USER

(71) Applicant: Lark Technologies, Inc., Mountain View, CA (US)

(72) Inventors: Julia Hu, Palo Alto, CA (US); Jeff Zira, Palo Alto, CA (US)

(73) Assignee: Lark Technologies, Inc., Mountain View, CA (US)

(21) Appl. No.: 14/048,956

(22) Filed: Oct. 8, 2013

Related U.S. Application Data
(60) Provisional application No. 61/710,867, filed on Oct. 8, 2012.
(60) Provisional application No. 61/710,869, filed on Oct. 8, 2012.
(60) Provisional application No. 61/827,909, filed on May 28, 2013.
(60) Provisional application No. 61/839,155, filed on Jun. 25, 2013.

(51) Int. Cl. G09B 19/00

(52) U.S. Cl. CPC G09B 19/00
USPC 434/236

(57) ABSTRACT

One variation of a method for prompting behavior change includes: receiving a first set of user activity data collected on a wearable device and on a mobile computing device during a first time period; identifying a habit within the first time period based on the first set of user activity data; assigning a classification to the habit; receiving a second set of user activity data collected on the wearable device during a second time period; based on the second set of user activity data, determining a deviation from the habit during the second time period; and generating a behavior change prompt to modify the habit based on the classification of the habit and the deviation from the habit that exceeds a threshold deviation.

### CROSS-REFERENCE TO RELATED APPLICATIONS

This application claims the benefit of U.S. Provisional Application No. 61/710,867, filed on 8 Oct. 2012, U.S. Provisional Application No. 61/710,869, filed on 8 Oct. 2012, to U.S. Provisional Application No. 61/827,909, filed on 28 May 2013, U.S. Provisional Application No. 61/839,155, filed on 25 Jun. 2013, which are incorporated in their entireties by this reference.

### TECHNICAL FIELD

This invention relates generally to the field of digital health, and more specifically to a new and useful method for providing real-time health-related advice in the field of digital health.

### BRIEF DESCRIPTION OF THE FIGURES

FIG. 1 is a flowchart representation of a first method of the invention;

FIG. 2 is a graphical representation in accordance with one variation of the first method;

FIG. 3 is a flowchart representation of one variation of the first method;

FIG. 4 is a flowchart representation of one variation of the first method;

FIG. 5 is a flowchart representation of one variation of the first method;

FIG. 6 is a schematic representation of one variation of the first method;

FIG. 7 is a flowchart representation of a second method of the invention; and

FIG. 8 is a graphical representation in accordance with one variation of the second method.

### DESCRIPTION OF THE PREFERRED EMBODIMENTS

The following description of the preferred embodiment of the invention is not intended to limit the invention to these preferred embodiments, but rather to enable any person skilled in the art to make and use this invention.

### 1. First Method

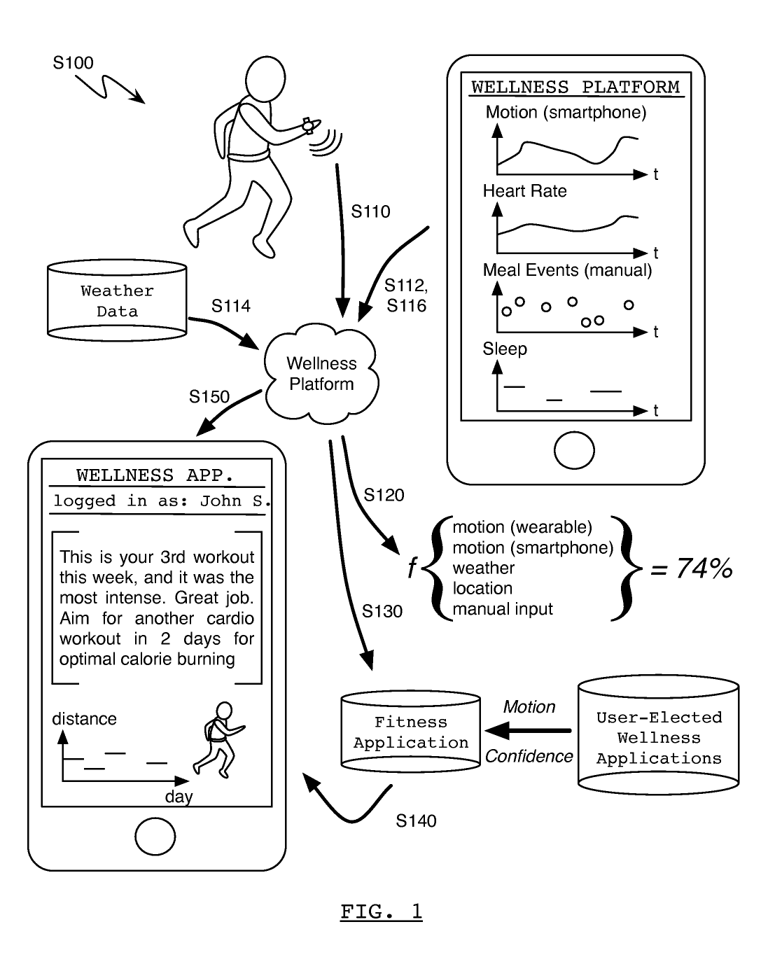

As shown in FIG. 1, a method for delivering behavior change directives to a user includes: receiving a first set of user motion data from a wearable device in Block S110; receiving a second set of user motion data from a mobile computing device in Block S112; calculating a confidence score for a determined user activity based on a comparison between the first set of user motion data and the second set of user motion data in Block S120; selecting a habit program defined within a wellness application elected (e.g., subscribed to) by the user in Block S130; and selecting a directive, from a set of directives associated with the habit program, based on the determined user activity and the confidence score for the determined user activity in Block S140.

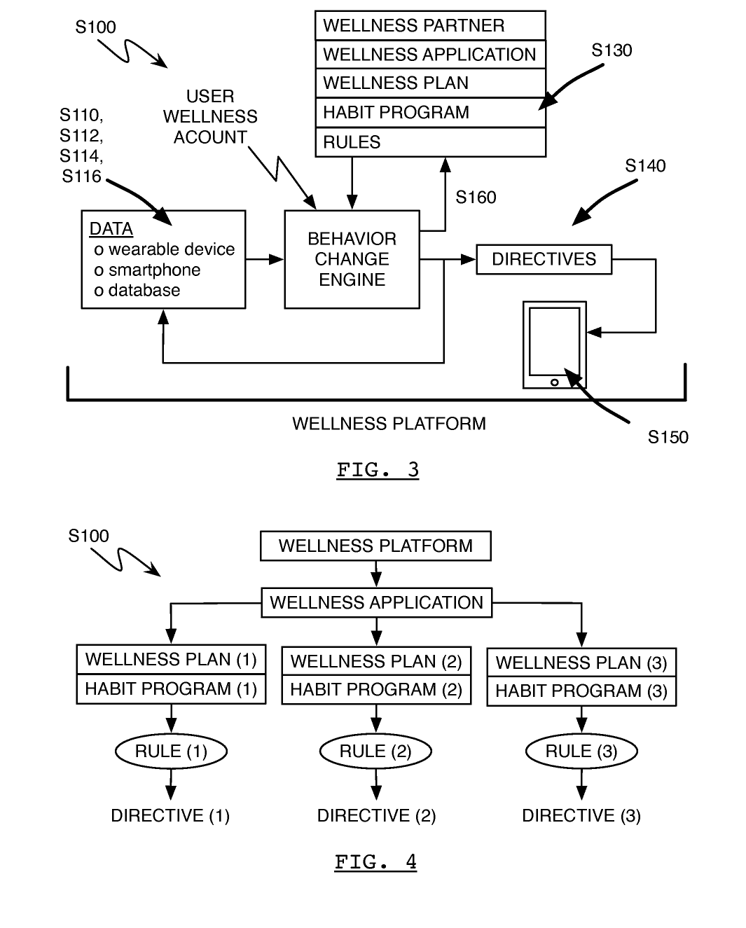

As shown in FIG. 3, first method S100 enables a behavior change engine within a wellness platform supporting wellness applications hosted by various wellness partners. Second method S200 generally functions to provide real-time contextual directives to a user to assist the user in achieving a wellness goal specified by a wellness application elected by the user. In particular, first method S100 applies a rule define within a wellness application to user motion or activity data, user location data, manual user input data, environmental data, user preferences, etc. to generate user-specific and immediately-relevant directives for the user.

Second method S200 can be implemented within a computational engine that emulates a coach (i.e., wellness expert) by returning real-time advice to a user based on wearable and mobile device sensor data, user behavioral patterns, machine learning algorithms, user-defined rules, environmental data, etc. Second method S200 can thus enable a behavior change engine within a self-serve wellness platform to support improvements in one or more wellness areas according to user selection of one or more relevant wellness applications on the wellness platform.

The wellness platform can enable the user to select and engage a wellness application supported by a third-party (i.e., external) wellness partner, such as a health insurance company, a diet program, a weight-loss system, a stress manager, a sleep program, a sports team, a college campus, a food vendor or grocer, a training program, a gym, etc. A wellness application can be related to one or more wellness categories, such as fitness, exercise, stress, sleep, and/or diet, and the wellness application can define a set of rules by which to aggregate user and/or environmental data to output a timely and relevant directive to assist the user in achieving a related goal in the associated wellness category. For example, first method S100 can load a set of rules from a selected wellness application into a behavior change engine to generate a directive to assist the user in creating positive habits and/or modifying or eliminating bad (or less than ideal) user habits. Second method S200 can also function within a private user wellness account through which the user can subscribe to one or more wellness applications.

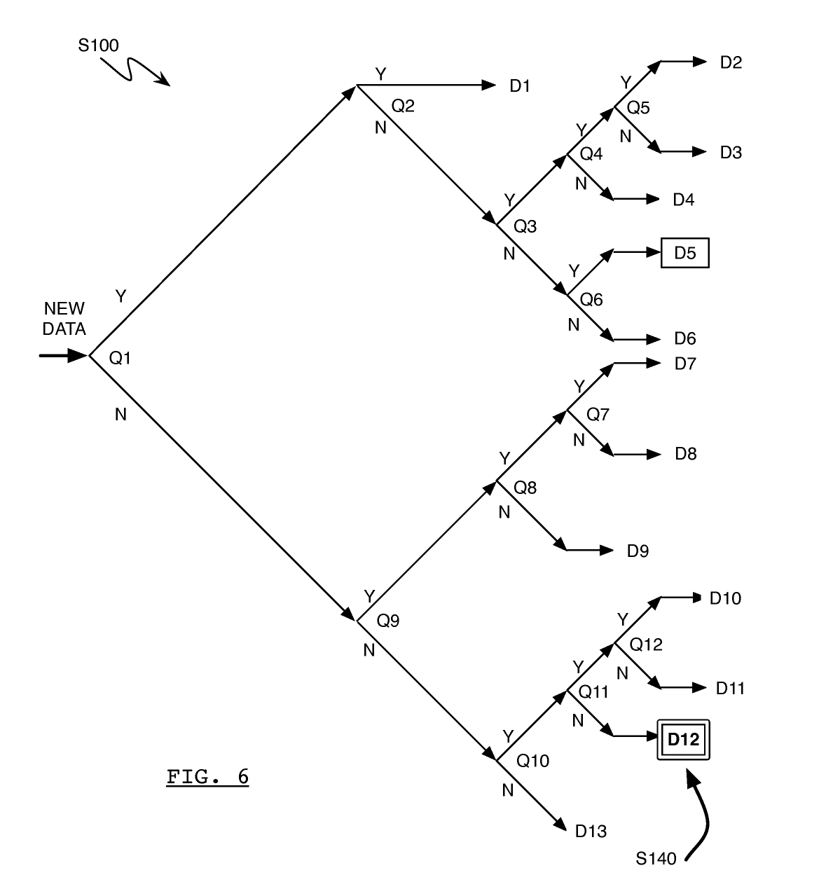

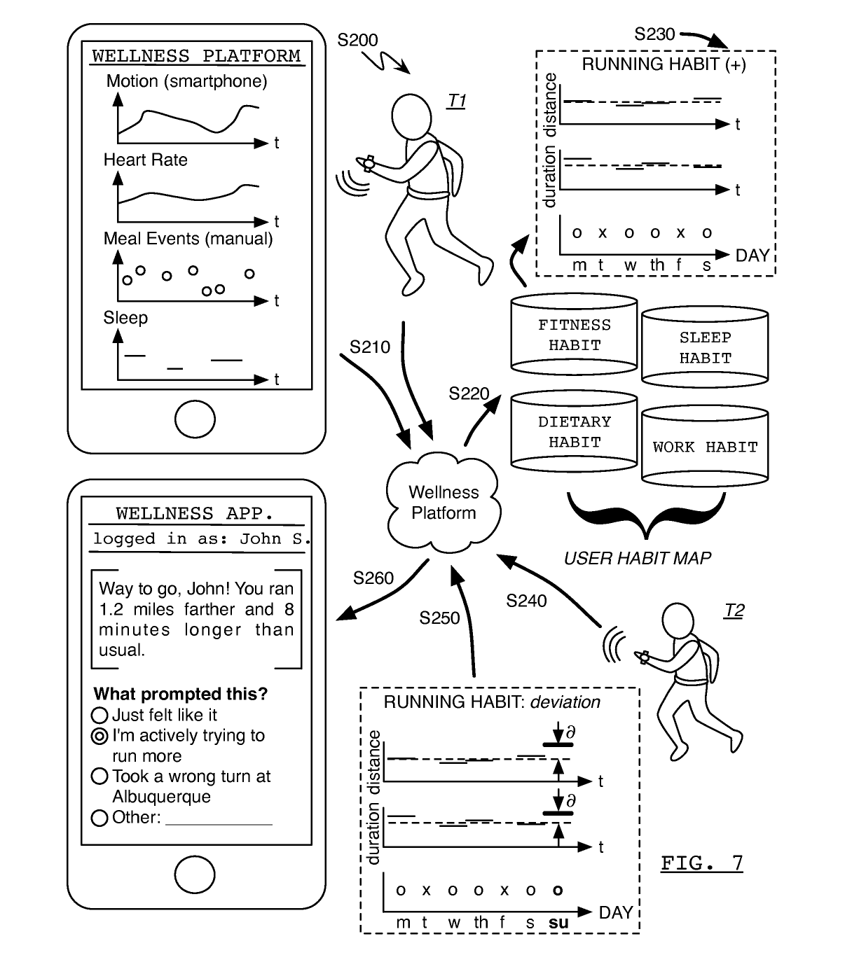

As shown in FIGS. 6 and 7, first method S100 can be implemented within a native wellness platform executing on a mobile electronic device carried by the user (e.g., a smartphone, tablet, smart watch, smart glasses, etc.) to deliver timely directives to the user. For example, Blocks of first method S100 can execute within a native wellness platform application on a smartphone, the native wellness platform application supporting multiple internal wellness applications to guide and support improvement in user wellness. Additionally or alternatively, one or more Blocks of first method S100 can be implemented within a user interface or a user dashboard accessible through a web browser, such as executing on a computer. Blocks of first method S100 can also be implemented on one or more computer systems, such as a cloud-based computer system, a mainframe computer system, a grid-computer system, or any other suitable remote computer system. For example, first method S100 can be implemented by a remote cloud-based computer system (e.g., a remote server) in communication with a smartphone carried by the user, wherein the remote computer system implements one or more Blocks of first method S100 remotely to select or generate a directive, and wherein the computer transmits the directive back to the smartphone for presentation to the user. However, first method S100 can be implemented by or in cooperation with any other one or more mobile computing devices, processors, computers, computer networks, etc.

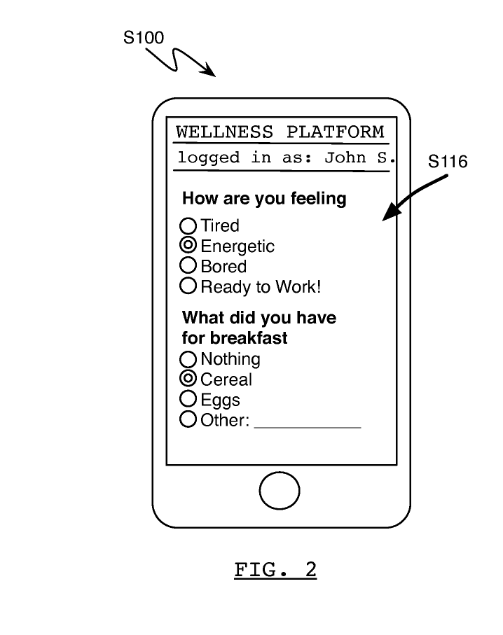

As shown in FIGS. 1 and 2, one or more Blocks of first method S100 can also interface with various hardware and/or software systems. For example, first method S100 can interface with an electronic wristband (or other wearable device) incorporating an accelerometer, a gyroscope, a temperature sensor, a magnetometer, and/or a display, such as the wristband described in U.S. Provisional Application No. 61/710,867, filed on 8 Oct. 2012, which is incorporated in its entirety by this reference. Second method S200 can thus receive user motion, temperature, and/or other user-related data from the wearable device over time. Blocks of first method S100 can also similar interface with an external device, such as a bath scale or a digital environment thermometer, to retrieve additional user or local environmental data. Second method S200 can similarly interface with (or be implemented on or through) a mobile computing device (e.g., a smartphone) incorporating a GPS sensor, communication channels (e.g., email, SMS text messaging), and a display, etc. to receive relevant user data, location data, calendar data, communication data, etc. and to output directives to the user accordingly. Furthermore, Blocks of first method S100 can interface with an email server to track user communications, a computer or other multimedia device to track user media consumption, a cloud-based calendar to track the user's schedule, a weather database to track local weather or environmental conditions, a social network to identify user relationships and/or track another form of user communications, a hospital database to retrieve and/or update user health records, etc. Second method S200 can therefore aggregate various user and environment data from multiple sources and implement this data—according to a wellness application within the user's wellness account—to output a directive for the user.

### 1.1 Motion Data

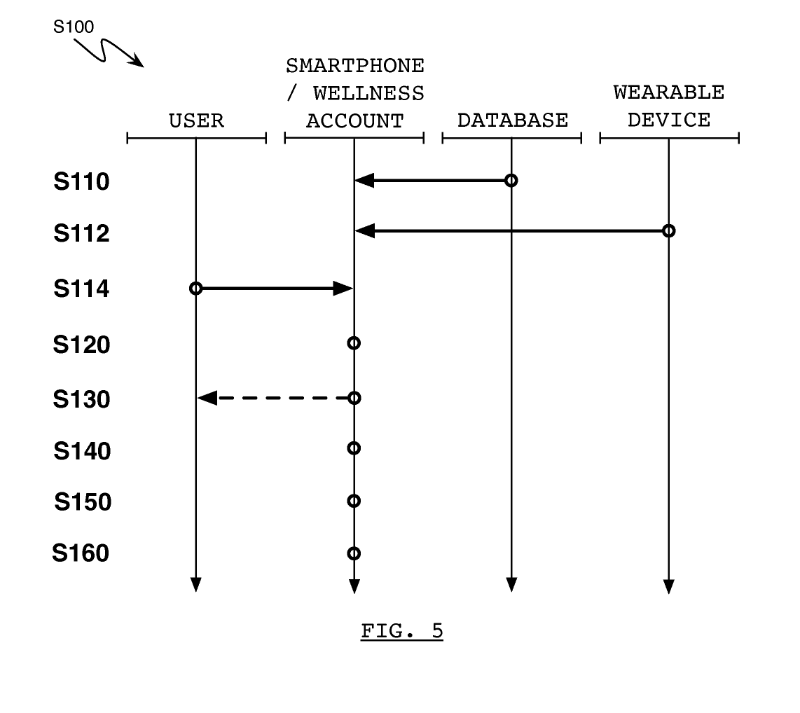

Block S110 of first method S100 recites receiving a first set of user motion data from a wearable device. Block S112 of first method S100 similarly recites receiving a second set of user motion data from a mobile computing device. Generally, Blocks S110 and S112 function to aggregate user and environmental data from multiple hardware devices, such as a wireless-enabled wearable wrist-borne device and a mobile computing device (e.g., smartphone) executing a native wellness platform, as shown in FIG. 5.

Block S110 interfaces with a wrist-borne device (“wristband”) worn by the user both at night and during the day to collect user sleep- and activity-related data collected by the wristband. For example, the wireless-enabled wristband can incorporate an accelerometer, a gyroscope, a temperature sensor, and/or a display, such as a wearable device described in U.S. Provisional Application No. 61/710,867, filed on 8 Oct. 2012, which is incorporated in its entirety by this reference, and Block S110 can thus receive user motion, temperature, and/or other user-related data as the user wears the wristband during the day and/or at night. In one example implementation, Block S110 downloads raw acceleration data from the wristband. For example, Block S110 can execute on a smartphone carried by the user and store the raw acceleration data locally on the smartphone for manipulation in subsequent Blocks of first method S100. Block S110 can additionally or alternatively upload the raw acceleration data to a remote cloud-based computer system (e.g., a remote server) for analysis and extraction of relevant user action and user activity data from the raw acceleration data. These extracted data can then be communicated back to the smartphone for immediate implementation in subsequent Blocks of first method S100.

Yet alternatively, the wristband can process motion data locally, extrapolate specific user actions and/or activities from data collected locally, and output action and/or activity tags, such as described in U.S. Provisional Application No. 61/839,155, filed on 25 Jun. 2013, which is incorporated in its entirety by this reference. In particular, the wearable device can locally compress raw motion data into one or more motion classifiers, such as compressed motion data (e.g., a compressed image of raw motion data), a user action (e.g., an instance extrapolated from compressed motion data), and a user activity (e.g., defined by a set of user actions). For example, the wearable device can generate action and/or activity tags (or timelines) and transmit these tags to the mobile computing device, and Block S110 can thus receive these tags substantially in real-time, such as substantially soon after generation on the wearable device, or asynchronously, such as every hour after a threshold number of user actions are identified, or every time a user activity (determined on the wearable device) changes with a suitable degree of confidence. However, Block S110 can collect user motion data from any other suitable type of wearable device worn in any other way by the user.

In one implementation, Block S110 collects user sleep data from the wristband while the user sleeps and/or after the user wakes from a period of sleep. For example, Block S110—executing on a smartphone—can sync (e.g., pair) with the wearable device (e.g., via Bluetooth), every morning once the user clears a silent alarm on the wearable device, the silent alarm indicating that the user is awake, that a period of user sleep has ended, and/or that the native wellness platform implementing first method S100 should switch from a “user sleep” mode to a “user awake” mode. Block S110 can thus download user sleep data for the foregoing night and pass this data to subsequent Blocks of first method S100 for analysis, such as to determine a quantity and a quality of the user's foregoing night of sleep. For example, first method S100 can apply the user's sleep quality and/or quantity to predict a user energy level and/or energy level pattern throughout the forthcoming day, such as based on past user sleep and activity data. Subsequent Blocks of first method S100 (e.g., Block S130) can also determine when the user went to bed (such as indicated by little to no movement after 9 pm), when the user woke (such as indicated by clearing an alarm through the wristband that also functions as a silent alarm), how long the user was in bed, how long it took the user to fall asleep, how many times the user woke during the night (such as indicated by certain movement patterns), the user's total time spent asleep, or the user's sleep quality (such as indicated by the total amount of user motion during sleep), etc. from sleep-related data collected from the wearable device in Block S110.

Block S110 can similarly receive user raw motion data or user activity and/or user action tags from the wearable device during the day, such as while the user eats, exercises, works, communes, etc. However, Block S110 can function in any other way to collect user action-related data over time from the wearable device, and subsequently Blocks of first method S100 can analyze these data in any other suitable way.

Block S112 can similarly interface with a mobile computing device incorporating various sensors to collect relevant user data. For example, Block S110 can execute on a smartphone or tablet and collect raw sensor data from an accelerometer and/or a gyroscope incorporated within the mobile device. Like Block S110 and/or the wearable device described above, Block S112 can characterize local motion data from the mobile device into action or activity tags, timelines, etc. For example, Block S112 can identify a pattern in current acceleration data recorded through an onboard accelerometer and implement template matching to pair the pattern in the current acceleration data with a motion pattern of a known action, such as walking, running, biking, swinging (a tennis racket, a baseball bat), drinking, eating, watching television, sleeping, working at a computer, lifting weights, cooking, etc.

### 1.2 Additional Sensor Data

Block S112 can also interface with a sensor within the mobile computing device to determine a current location of the user. For example, Block S112 can interface with a Global Positioning System (GPS) sensor within the mobile computing device to retrieve a GPS coordinate position of the mobile computing device and then correlate this position with the current position of the user. Block S112 can additionally or alternatively interface with a cellular transceiver within the mobile computing device to triangulate the position of the mobile computing device relative to various local cellular towers. However, Block S112 can function in any other way to collect location data through the mobile computing device and to correlate these location data with the user's current (or previous) location.

Block S112 can similarly interface with other sensors within the mobile computing device to collect additional user and/or environmental data. For example, Block S112 can collect ambient light level data from a light sensor integrated into the mobile computing device, ambient noise level data from a microphone integrated into the mobile computing device, or ambient temperate data from a temperature sensor within the mobile computing device.

Block S112 can further interface with a local database on the mobile computing device or a remote databases in communication with the mobile computing device to collect additional user data. In various examples, Block S112 can interface with a local email client and/or an email server to collect user email information (e.g., email flux, timing, response types), a native phone call application or a voice-over-IP server to collect user phone call data, a device operating system or a media server to collect user media consumption data (e.g., music, video, images, consumption rate and trends), and/or a native calendar application or a personal data server to retrieve user calendar events and notes, etc. Block S112 can therefore interface with one or more data systems hosted internally on the mobile computing device or externally on a remote database, server, or computer system to access additional relevant user information.

Block S110 can similarly collect additional data from the wearable device, such as heart rate data collected through a heart rate sensor within the wearable device or user body temperate data collected through a temperature sensor within the wearable device. Block S110 can also interface with another standalone external device. For example, Block S110 can receive user weight data from a wireless-enabled digital bath scale or local ambient temperature or barometric pressure from a wireless-enabled thermometer or other environmental sensor. In these implementations, the mobile computing device hosting the native wellness platform can communicate with one or more external devices (e.g., the wearable device, a scale, an environmental sensor) over short-range communicate protocol, such as Bluetooth or Wi-Fi, or any other suitable communication protocol over any other suitable range.

### 1.3 Environmental Data

One variation of first method S100 includes Block S114, which recites retrieving environmental data from a remote database. Generally, Block S114 functions to retrieve environmental data from an external database and/or an external software system. For example, Block S114 can retrieve a local weather forecast for a location of the mobile computing device determined in Block S112, such as temperature, humidity, rainfall or chance of rain, and sunshine, fog, or cloud cover, etc.

### 1.4 Manual Data

As shown in FIG. 2, one variation of first method S100 includes Block S116, which recites prompting manual entry of user wellness data into the mobile computing device. Generally, Block S116 functions to receive manual user entry of relevant user data, such as through a user interface within the native wellness platform executing on the mobile computing device.

In one implementation in which a wellness application within the native wellness platform is elected by the user, Block S116 selects a prompt defined by the wellness application, presents the prompt to the user, and collects the user's response to the prompt. In one example, a diet application—elected to the user's wellness account and executing within the native wellness platform on the user's mobile computing device—defines a prompt asking the user if and what he consumed for breakfast and a time window in which to present the prompt the user. In this example, Block S116 can select the prompt based on the time of day and communicate the prompt to the user, such as through a notification on the mobile computing device at the time specified by the diet application or based on a learned meal or dietary habit of the user (e.g., an average daily breakfast completion time for the user). In this example, once the user enters a response to the prompt, such as by selecting from a set of available responses or by inputting a custom textual response, Block S116 can pass the user's response to the corresponding diet application within the user's account. Block S116 can additionally or alternatively prompt the user to enter data through another device, such as by selecting an input region on a wearable device, by opening a web browser and completing a survey, etc. to collect a user response to a prompt defined within a wellness application.

In another implementation, Block S116 prompts the user to enter personal information. For example, Block S116 can present to the user a prompt reciting, “Hi Lily. What's the most important reason that you're dieting?” and subsequently collect a response from the user that includes, “I'm doing it for my kids.” In this implementation, Block S116 can pass the user's response to Block S140 to select a subsequent directive for the user. As in the foregoing example, Block S140 can implement the user's response to generate a directive that includes, “Hi Lily. I know dieting is tough, but if you're having trouble, be sure to remember why you're doing it. You said that you were doing this for your kids.” Block S116 can thus collect personal information from the user, and Block S140 can apply the user's personal information to generate custom, personal directives for the user.

Block S116 can also interface with the wearable device to collect user responses to an explicit or implicit prompt. For example, when the user consumes something, such as a glass of water, a snack, or a full meal, the user can record consumption by engaging an input region on the wearable device, such as by pressing and holding a button on the wearable device or double-tapping a surface of the wearable device. The wearable device can record the input as a consumption indicator and tag the input with a timestamp, such as according to an internal clock maintained by the wearable device. When the mobile computing device syncs with the wristband (e.g., every hour), Block S116 can download consumption indicators and associated time tags stored on the wearable device and add these consumption data to a timeline of user actions or activities. Block S116 can thus interface with the wearable device to log activity data, such as the time, type, size, etc. of a meal, by engaging a readily-accessible input region on a wearable device. Block S116 can further prompt and/or enable the user to add additional consumption details (e.g., a meal size, category, quality, content, etc.) to the consumption data received from the wearable device indicators, such as in real-time or asynchronously. By recording such additional user consumption data, Block S116 can enable subsequent Blocks of first method S100 to further identify a relationship between user activity level, sleep patterns, etc. and user consumption.

### 1.5 User Activity

Block S120 of first method S100 recites calculating a confidence score for a determined user activity based on a comparison between the first set of user motion data and the second set of user motion data. Generally, Block S120 functions to combine data collected from multiple sources to determine a user activity during a period of time and to assign a degree of confidence in the determined user activity based on variance between data from the multiple sources. By assigning a quantitative metric to how strongly motion (and other) data collected through the wearable device and the mobile computing device (and remote database, etc.) correlate and match existing action or activity models, Block S120 can enable Block S140 to selectively respond to determined user actions or activities occurred with a reasonable confidence. For example, Block S120 can assign a determination that the user walked for eight minutes at a first time with a confidence of 82% and that the user biked for three minutes at a second time with a confidence of 58%, and Block S140 can select a directive for the user in response to the determined walking activity during the first period but not select a directive for the user in response to the possible biking activity during the second period.

In one implementation, Block S120 extrapolates a user action or a user activity from motion data collected on the mobile computing device. Generally, in this implementation, Block S120 can implement machine learning, activity characterization algorithms, pattern extraction and recognition, statistical methods, template matching, lookup tables, or any other suitable analytic technique to determine a user action or activity from raw or compressed motion data collected in Block S112. For example, Block S120 can implement pattern recognition to analyze accelerometer and/or gyroscope data collected in Block S112 and automatically group identified user actions (or activities) based on classifications of recognized motion patterns. In this example, Block S120 can analyze raw three-dimensional accelerometer data to count the user's steps. Block S120 can similarly classify motion data as biking, walking, driving, raking the grass, playing tennis or basketball, swimming (and the user's type of stroke), etc. Block S120 can also determine if the user is sedentary, such as based on a period of composite accelerometer (e.g., three-axis) amplitudes falling below a threshold acceleration. Block S120 can also characterize user motion data to determine if the user is sleeping and the user's current sleep cycle, such as described in U.S. Provisional Application No. 61/710,869, filed on 8 Oct. 2012, which is incorporated herein in its entirety by this reference. For example, for acceleration data recorded through the wristband worn on the user's wrist, Block S120 can correlate small, high amplitude, oscillatory accelerations accompanied by little or no gradual, low amplitude acceleration with typing and little to no overall acceleration with sleeping or resting. Block S120 also can correlate smaller amplitude, more gradual, and oscillatory accelerations with walking and similar, higher-amplitude accelerations with jogging or running, through Block S120 can correlate raw user motion data with any other action or activity.

Block S120 can determine a user action from motion data collected on the mobile computing device substantially in real-time, such as within one minute of user initiation of an action or activity. Block S120 can alternatively correlate motion data from a user activity asynchronously, such as by analyzing motion data within predefined time periods or blocks (e.g., thirty-minute time blocks).

In implementations in which Block S110 receives raw or compressed motion data (or baseline user action classifiers) from the wearable device, Block S120 can implement similar methods or techniques to correlate data collected through the wearable device with a particular user action and/or activity.

Block S120 can also filter out accelerations that are not repetitive and/or that is associated with an action that occurs over less than a threshold period of time, such as five minutes. In this implementation, Block S120 can generate a comprehensive list of significant user actions or activities of the user over a period of time based on data collected from the wearable device, a mobile computing device, and/or various other databases, sensors, etc.

Once a user action or activity is associated with each of the motion data sets from the mobile computing device and the wearable device, Block S120 compares the actions or activities of each to quantify a degree of confidence that the determined user action or activity during the corresponding time period is accurate. Generally, Block S130 can thus function to verify a user action or activity determined from data originating with the wearable device and/or the mobile computing device. In one example, if a determined user action from data collected at the wearable device substantially matches a determined user action from data collected at the mobile computing device, Block S120 assigns a high degree of confidence to the determined user action. In particular, in this example, if the data collected at the wearable device is associated with a “walking” action for eight minutes and the data collected at the mobile computing device is associated with a “walking” action for eight minutes, Block S120 can assign a confidence between 95% and 100% to the determined “walking” action. Similarly, in this example, if the data collected at the wearable device is associated with a “walking” action for eight minutes and the data collected at the mobile computing device is associated with a “walking” action for a six-minute period substantially centered within the foregoing eight-minute period, Block S120 can assign a confidence between 95% and 100% to the determined “walking” action for the six-minute period and a confidence between 80% and 90% to the determined “walking” action to a portion of the eight-minute period that does not overlapping the six-minute period. In another example, if a determined user action from data collected at the wearable device does not matches a determined user action from data collected at the mobile computing device, Block S120 assigns a low degree of confidence to the determined user action. In particular, in this example, if the data collected at the wearable device is associated with a “walking” and the data collected at the mobile computing device during a corresponding period is associated with a “biking” action, Block S120 can assign a confidence between 0% and 10% to the determined “walking” and “sleeping” actions. Similarly, in this example, if the data collected at the wearable device is associated with a “walking” action and the data collected at the mobile computing device during a corresponding period is associated with a “running” action, Block S120 can assign a confidence between 45% and 55% to the determined “walking” and “running” actions. As in this example, Block S120 can apply additional data, such as environmental, manual input, location, or other data to verify one action over another, as described below. For example, Block S120 can analyze location data collected in Block S112 during the corresponding period of time to determine if the user's displacement over time correlates with walking or running.

Block S120 can additionally or alternatively compare a determined user action (i.e., determined from motion data collected at the wearable device and/or at the mobile computing device) to user location data collected in Block 112. For example, Block S120 can correlate a location received in Block S112 with a gym or fitness center, identify a low correlation (i.e., low confidence) between the location and a “cooking” action determined from data collected at the wearable device, and assign a low confidence to the determined “cooking” action accordingly. In another example, Block S120 can correlate a location received in Block S112 with the user's home, identify a high correlation between a “sleeping” action determined from data collected at the wearable device and a 2 AM timestamp associated with the motion data, and assign a high confidence to the determined “sleeping” action accordingly. Block S120 can therefore associate a location with a particular an action or an activity, such as based on a common action taken by the user at a location or by other users at the location, based on a common action taken by other uses at similar location, or based on a predefined set of actions common to certain location or locations of certain types.

Block S120 can also verify an action determined from motion data collected in Block S110 and/or Block S112 based on one or more of environmental data, manual user input data, calendar data, etc. For example, Block S120 can determine that the user is “eating” during a period of time, identify a correlation between the “eating” action and a calendar event specifying a restaurant location for the period of time, and thus assign a high correlation between the “eating” action and the corresponding motion data.

Block S120 can further assemble user motion data, action data, activity data, etc. into a user timeline (e.g., over several days or weeks) and identify trends in the user's behavior or “habits.” Block S120 can thus compare a new determined user action to an identified user habit, determine a deviation of the determined action from the user trend, and assign a confidence in the determined action accordingly, such as described below. For example, if a “driving” action is determined from motion data between 7:45 AM and 8 AM and user history indicates that the user is 85% likely to walk between 7:45 AM and 8 AM (e.g., for a morning dog walk), Block S120 can assign a low confidence to the determined “driving” action. In this example, Block S120 can then implement other data to verify or correct the low confidence score. For example, Block S120 can implement location data to verify a speed of travel consistent with driving, weather data to verify rain or snow that may preclude a dog walk, or a calendar event to identify a schedules event requiring motorized travel around 8 AM on the current day.

However, Block S120 can implement any other one or more types of data in any other way to verify a user action determined from motion data collected from the wearable device in Block S110 and/or from the mobile computing device in Block S112. Block S120 can further implement machine learning to improve determination of a user action or activity, identification of user action or activity trends (e.g., habits), and application of disparate data to generate confidence scores for determined user actions or activities. In particular, Block S120 can apply machine learning techniques to improve an action or activity model or determination algorithm over time with data form the user and/or from other users to yield determined actions of ever-increasing confidence scores.

Block S120 can thus pass the determined confidence in the determined user action or activity to Block S140, and Block S140 can implement the determined confidence to selectively respond to only determine actions that are known with a suitable degree of confidence. Block S140 can set a static confidence threshold (e.g., 65%) that the determined action is accurate for all determined actions, or Block S140 can set a static confidence thresholds for different types of determined actions, activities, times of day, etc. For example, Block S140 can set a high confidence threshold (e.g., 90%) for common actions, such as walking or running (e.g., because models to identify walking and running may be well-taught with relatively large amounts of data from a large number of users), whereas Block S140 can set a low confidence threshold for uncommon actions (e.g., 65%), such as throwing shot-put (e.g., because models to identify throwing shot-put may not be well-taught due to lack of a relatively large amount of shot-put motion data). Block S140 can additionally or alternatively dynamically set confidence thresholds, such as based on time of day. For example, Block S140 can set a high confidence threshold (e.g., 90%) for walking on weekdays between 12 PM and 2 PM, a medium confidence threshold (e.g., 80%) for walking on weekdays between 8 AM and 12 PM and between 2 PM and 8 PM, and medium-low confidence threshold (e.g., 70%) for walking on weekdays between 6 AM and 8 am and between 8 PM and 11 PM, and a low confidence threshold (e.g., 60%) for walking on weekdays between 11 PM and 6 AM.

### 1.6 Habits

Block S130 of first method S100 recites selecting a habit program defined within a wellness application elected by the user. Generally, Block S130 functions to select a habit program—from a set of habit programs corresponding to a wellness application elected by the user—that is related to the determined user action or activity and to pass this selected habit to Block S140 for selection of a particular directive from a set of directive corresponding to the habit program. Each wellness application can define one or more habit programs specifying a course for improving a health and/or wellness component of a user's life. Each habit program can specify a positive (i.e., good) habit or a negative (i.e., bad) habit and include a pre-populated list of directive for supporting (e.g., guiding) the user in improving a positive habit and/or mitigating a negative habit.

A wellness application supported by the native wellness program (and executing on the user's mobile computing device) can define rules for collecting, handling, and/or manipulating user, environmental, and related data to output coaching-type directives in a corresponding wellness area for the user. A wellness application can be associated with a particular wellness goal, such as weight loss, stress management, an exercise achievement (e.g., completing a marathon), etc., and the wellness application can provide custom coaching services and coaching content to the user through the wellness platform. As shown in FIGURES and 4, the wellness application can specify a wellness plan, such as a diet or a workout plan, and the wellness plan can define a highest-level container of rules associated with a user's wellness goal. The wellness plan can include multiple habit programs, wherein each habit program defines one or mode habits for the user to create, modify, reinforce, or eliminate. The wellness plan can therefore define one or more “major” habits (e.g., a diet-related habit, an activity-related habit) and/or “minor” habits (e.g., a sleep-related habit, a mood-related habit), such as on a user-specific basis. The wellness plan can thus include a step-by-step program for habit building, and the user can progress through the wellness plan by achieving the goal(s) of one habit program at a time.

Block S130 can therefore filter out a wellness application—and specify a habit program within a user-elected wellness application—for which a new determined user action or activity is substantially pertinent. For example, Block S130 can select a diet-related habit program defined within a diet-related wellness application elected by the user and pass a pointer to the selected diet-related habit program to Block S140 for selection of a directive corresponding to the diet-related habit program and the determined user action (e.g., a diet-related directive to reinforce a diet-related habit). However, Block S130 can function in any other way to pair the determined user action with one or more wellness applications and/or one or more habit programs in one or more user-elected wellness application.

### 1.7 Directives

Block S140 of first method S100 recites selecting a directive, from a set of directives associated with the habit program, and based on the determined user activity and the confidence score for the determined user activity. Generally, Block S140 functions to implement one or more rules defined by the habit program selected in Block S130 to generate a timely reminder to perform a future action and/or to generate timely feedback in response to a recent user action, new user data, and/or new environment data. In particular, Block S140 selects a directive pertaining to a particular habit program to provide guidance to the user as the user progresses through a corresponding wellness program in response to new user action or activity data associated with suitable degree of confidence. Block S140 can also aggregate streams of data (e.g., from Blocks S110, S112, S114, S116, etc.) and convert the streams of data into messages and/or actions based on a rule specified by a wellness plan, the directive selected to motivate the user to improve his wellness in an elected wellness area (e.g., fitness, diet, stress, energy level, etc.). For example, Block S140 can select the directive based on a weather forecast specified in the environmental data or in response to user data manually input by the user, such as described below.

Block S140 can apply rules specified in a current habit program to generate a reminder (a first directive type) to perform an action to achieve a habit-related goal specified in a current habit program and/or to generate feedback (a second directive type) for a recent user action or inaction pertaining to the current habit program. For example, in a first weeklong habit program of the wellness plan, Block S140 can output a reminder to “log all meals,” and, in a second weeklong habit program of the wellness plan, Block S140 can output a reminder to “log two vegetables per day.” The user can be engaged in multiple habit blocks within one wellness application simultaneously, such as one habit program that builds on another habit program, and Block S116 can thus prompt the user to enter wellness data pertaining to multiple habit blocks and/or multiple wellness plans within a period of time (e.g., within one hour).

In one implementation, the wellness application includes pre-populated list of reminders, and Block S140 generates a reminder by selecting a reminder from the pre-populated list. In one example, the wellness application can define a decision tree with a complete reminder at each node in the decision tree, as shown in FIG. 6, and Block S140 move through branches of the decision tree according to user and/or environmental data to select a particular reminder at a particular node. In a similar example, the wellness application can define a decision tree with a form reminder at each node, and Block S140 move through branches of the decision tree according to user and/or environmental data to select a particular reminder at a particular node and then complete the form reminder with relevant user and/or environmental data. In the foregoing examples, the wellness application can include one decision tree for all habit programs, one decision tree per habit program or habit, or any other number of decision trees. The wellness application can include a similar decision tree(s) for feedback, and Block S140 can apply similar methodology to select or generate feedback.

In another example, a wellness application can define a decision graph with each node in the graph pointing to at least one other node in the graph such that Block S140 can move through branches of the decision tree over time without reaching a dead-end or final node. However, Block S140 can generate and/or select a reminder and/or feedback in any other suitable way.

A reminder can function to serve a habit-building action to the user and can be based on a habit program currently engaged by the user (and selected in Block S130). In one example, for a diet-related wellness application in which the user is currently engaged in a food preparation habit-building program, Block S140 can apply user location data to select a reminder to prompt the user to purchase a particular foodstuff when the user is within a threshold distance of a grocer. In another example, for a marathon training wellness application in which the user is currently engaged in a daily ten-mile training program, Block S140 can apply current and forecast weather data to select a reminder to prompt the user to begin a scheduled run one hour earlier to avoid a forecast rainstorm. Therefore, Block S140 can select or generate reminders including content that is appropriately served to the user at particular time, such as when the user is in or near a particular location or about to engage in a particular activity.

In various examples, Block S140 can select a reminder that includes any of the following: 1) “You're 300 calories short of your calories burned goal, walk to the Giants game instead of taking a cab . . . don't worry, you'll make it on time!” 2) “Hey, your average walk to work is 12 minutes. Why not try to beat your best time and do it in 11?” 3) “It's going to rain in one hour, so let's get that run in right now!” 4) “The weather has changed unexpectedly, and that run doesn't look like it's going to happen. Hit the local gym on 24th street and do your interval sessions on the treadmill.” 5) “Hey, good morning. Here's your workout plan for the week. I'll ping you to remind you to get your gym clothes.” However, Block S140 can generate or select any other reminder including any other suitable content.

Feedback can function to serve habit reinforcement, encouragement, and/or empathy to the user in response to a user action and/or inaction. Block S140 can select or generate feedback based on a habit program currently engaged by the user and/or based on new user data and/or new environmental data. As in the foregoing example in which the user is currently engaged in a food preparation habit-building program of a diet-related wellness application, Block S120 can determine that the user entered the grocer in response to the related reminder, Block S116 can prompt the user to confirm purchase of the particular foodstuff, and Block S140 can select feedback that includes a recipe for the foodstuff for the user as reward for completing the action specified in the reminder. Furthermore, as in the foregoing example in which the user is currently engaged in a daily ten-mile training program within a marathon training wellness application, Block S120 can analyze accelerometer data from a wearable device to determine that the user is running, and Block S140 can select feedback congratulating the user for completing the run before the forecast rain time. Therefore, Block S140 can select or generate feedback including content that is appropriately served to the user after a particular activity or inactivity. In particular, Block S140 can output feedback in response to a user action determined (e.g., estimated, predicted) in Block S120.

In various examples, Block S140 can select feedback that includes any of the following: 1) “Hey—great tennis you played there! It got you to your daily goal. Would you like us to remind you the same time next week to do a workout?” 2) “You had your best workout listening to these songs, this genre . . . do you want your music player to curate another playlist for tomorrow's workout?” 3) “This is your 3rd workout this week, and it was the most intense. Great job. Aim for another cardio workout in 2 days for optimal calorie burning.” 4) “You spend five hours of your workday completely sedentary. That's way above average. Taking a walking break now would break up the day and could get you to your daily step goal.” 5) “You burn the most calories on Thursdays, and the least on Wednesdays, so let's up your Wednesday count by doing a fifteen-minute walk now.” 6) “You're a workout pro. You worked out four times a week and burned 450 calories on average. You're rocking it!” 7) “You're 500 steps short of your daily steps goal, but grocery shopping is on your calendar and is a great way to get these last steps in before the end of the day.” 8) “Hey, you had a faster pace today! It might have been because of the outside temperature. Look how the past few day's temperature has impacted your performance.”

Block S140 can also select or generate a directive that includes a combination of a reminder and feedback. Block S140 can further generate or select multiple directives substantially simultaneously, such as if the user has added multiple wellness applications to his wellness account.

In one implementation, Block S140 preselects a first directive from the set of directives corresponding to the selected habit program, such as based on an anticipated action of the user. For example, as described above, Block S120 can track action or activity trends of the user over time to identify various user habits, and Block S140 can preselect a future directive (the first directive) according to an anticipated action based on an identified user habit. Block S140 can also set a trigger to either serve the first directive to the user or to select an alternative directive for the user. For example, for a user habit characterized by omission of an action, Block S140 can select the first directive that includes a reminder to complete an action and then serve the first directive to the user if Block S120 determines that the user has not completed the action by a specified time (within a threshold confidence). However, in this example, if Block S120 determines that the user has completed the associated action, Block S140 can deselect the first directive and select an alternative directive that responds to completion of the action by the user. By pre-selecting the directive, Block S140 can reduce immediate processing time required to respond to a user action, activity, or trigger by selecting a potential directive before a user action or activity is detected or a trigger fires. For example, Block S140 can be implemented on a remote server that services a large number of user, and Block S140 can process a user habit and a current habit program to preselect a directive during off-peak hours such that the preselected directive can be substantially immediately served to the user—if applicable—without necessitating delay while data from other users is processed on the server to select other directives.

However, Block S140 can generate or select any other feedback including any other suitable content in any other suitable way.

### 1.8 Directive Delivery

As shown in FIGS. 1 and 3, one variation of first method S100 includes Block S150, which recites displaying the directive on a display of the mobile computing device. Generally, as shown in FIG. 1, Block S150 functions to receive a directive from Block S140 and to present the directive to the user, such as through a user interface within a native wellness platform executing on a mobile computing or wearable device or through a dashboard accessible through a web browser on a computing device. For example, first method S100 can provide a personalized coaching experience to a user-user based on a user-selected goal (e.g., losing a few pounds, reducing stress) by pushing real-time recommendations and/or personalized content to a watch, a smartphone phone, an email account, and/or an online dashboard in Block S150.

Block S150 can support multiple communication channels, such as in the form of one chat-style textual communication channel for each wellness application, wherein Block S150 publishes (e.g., pushes) a directive for a particular wellness application into a communication channel of an associated wellness application. Block S150 can additionally or alternatively communicate directives to the user as pop-up messages notifications, emails, SMS text messages, or any other suitable type textual communication, such as through a mobile computing device, a wearable device, etc. Block S150 can also communicate visual or audible directives to the user. Block S150 can also communicate video, music, calendar updates, progress screens, or other media to the user.

In one implementation, Block S150 interfaces with an intelligent personal assistant (i.e., a mobile software agent) executing on a smartphone (or other mobile computing device) to communicate directives to the user through a voice emulator. For example, Block S150 can emulate a live coach and enable two-way communication between the user and the user's wellness account through the intelligent personal assistant. In this example, Block S150 can interface with the intelligent personal assistant to enable the user to interact in a back-and-forth conversation with the system to give and receive details and directives pertaining to a wellness plan, user- and/or program-specified goals, habits and/or habit programs, user actions, needs, or interests, user questions, empathy, etc.

In this implementation, Blocks S114, S116, and/or S140 can interface with the intelligent personal assistant to collect user and/or environmental data. For example, the intelligent personal assistant can enable Block S116 to present a question to the user and retrieve a response from the user, such as through a voice recognition applet within the intelligent personal assistant, Block S140 can implement the user's response to generate or select a relevant directive, and Block S150 can output the directive to the user in a spoken language format. Therefore, Blocks of first method S100 can interface with an intelligent personal assistant executing on or accessible through a mobile computing device, wearable device, or other electronic device (e.g., through a web browser on a desktop computer) to communicate directives to the user and/or to receive data from the user.

### 1.9 Habit Adoption

As shown in FIG. 3, one variation of first method S100 includes Block S160, which recites: identifying repetition of the determined user activity as a user routine within a time period corresponding to the first set of user motion data; correlating the routine with a habit specified in the habit program; based on the user routine, determining a deviation from the habit during the time period; for a deviation less than a threshold deviation, predicting adoption of the habit by the user; and, in response to adoption of the habit by the user, selecting a subsequent habit program defined within the wellness application.

Generally, Block S160 functions to identify a user habit (“routine”) based on user data collected over time, to match the user habit to a habit specified in a wellness application, and to identify adoption of the habit specified in the wellness application based on limited deviation between the identified user habit and the habit specified in the wellness application. For example, for a dietary wellness program subscribed to by the user including a current habit program specifying consumption of a leafy vegetable during lunch for at least five day out of every week, Block S160 can determine that the user has adopted the current habit program in response to user consumption of a leafy vegetable on an average of 5.4 days per week for eight consecutive weeks. In this example, Block S160 can turn off the current habit program and select a new habit program specifying consumption of two liters of water each day within the dietary habit program.

Block S160 can thus automatically trigger progression to a subsequent habit program with a wellness application once user adoption of the current habit program is confirmed or identified within a threshold degree of confidence. Block S160 can further toggle habit programs off and on within the wellness application as the user adopts a positive habit (or loses a negative habit) and begins to lose a positive habit (or builds a negative habit), respectively. In one implementation, Block S160 applies habit identification and deviation methods and techniques described below in the second method. Block S160 can also apply other data, such as location and environmental data, to identify user adoption of a particular habit. However, Block S160 can function in any other way to identify and respond to habit adoption by the user.

### 1.10 API/SDK

The wellness platform implementing the behavior change engine enabled by first method S100 can provide integration tools to a wellness partner to enable software integration within a corresponding wellness application. In one implementation, the wellness platform supports an application programming interface (API) and/or software developer's kit (SDK) to provide the wellness partner with access to platform-hosted data retrieval for data hosted on one or more remote databases. For example, for the wellness partner that hosts a stress management program, the SDK can enable the wellness partner to assign email-related data (e.g., influx, timing, responses), calendar data, and local weather data (any of which may be stress indicators or affect stress) to the stress management program. In this example, once the user loads the stress management program to his wellness account, Block S114 can collect email-related data, calendar data, and local weather data from associated databases on behalf of the stress management program.

The API and/or SDK can also provide the wellness partner with access to local data stored on the mobile computing device and/or on the wearable device. For example, for the wellness partner that hosts the stress management program, the SDK can provide the wellness partner with local user email data and calendar data stored directly on the device. The API and/or SDK can further enable the wellness partner to define new data channels to feed data through the wellness platform and into an associated wellness plan. In one example, for the wellness partner that hosts the stress management program, the SDK can enable the wellness partner to define a new connection to a hospital database and/or to a psychotherapy database to retrieve user health and/or therapy data (e.g., in a user medical record). In another example, for a wellness partner that hosts a diet program, the SDK can enable the wellness partner to define a new connection to a local grocer (e.g., to retrieve specials or inventory data), to a restaurant database (e.g., to retrieve nutritional content for menu items), or to a forum hosted by the wellness partner to support diet program members.

Second method S200 can therefore support an SDK, an API, and/or any other framework to enable a wellness partner to tap existing data channels already supported by the wellness platform and/or to enable a wellness partner to create new data channels to funnel relevant user and/or environmental data into the wellness platform from external databases.

The wellness platform can also provide integration tools to a wellness partner to enable hardware integration within an associated wellness application. In one implementation, the API and/or and SDK provides the wellness partner with access to data collected from one or more sensors within a wearable device, a mobile computing device, and/or an external device, etc. For example, for a wellness partner that hosts a fitness program, the SDK can enable the wellness partner to assign accelerometer data from a wearable device and location data from the mobile computing device to the fitness program. In this example, once the user loads the fitness program to his wellness account, Block S110 can collect motion data from an accelerometer within the wearable device and GPS location data from a GPS sensor within he mobile computing device on behalf of the fitness program. The wellness platform can therefore enable a wellness partner to build (or provide, host) an associated wellness application that sources data from one or more general, generic, program-agnostic, and/or platform-specific devices.

The API and/or SDK can also enable the wellness partner to define new sensor channels to feed data from other generic and/or wellness plan-specific devices into the user's wellness account and thence into an associated wellness plan. In one example, for the wellness partner that hosts a fitness management program, the SDK can enable the wellness partner to define and/or upload communication protocols for a proprietary wearable step counter such that, when worn by the user, provides step data that is accessible only to the wellness plan(s) hosted by the wellness partner to the user's wellness account. In another example, for a wellness partner that hosts a diet program, the SDK can enable the wellness partner to define and/or upload communication protocols for a proprietary digital device including a bath scale and body mass index (BMI) sensor that, when stood on by the user, communicates user weight and BMI data to the user's wellness account, wherein the user weight and BMI data are accessible only to the wellness plan(s) hosted by the wellness partner. The wellness platform can therefore enable a wellness partner to build an associated wellness application that sources data from one or more proprietary or wellness partner-specific devices. The wellness platform can similarly enable a wellness partner to define and/or upload communication protocols for a new or additional general, generic, and/or program-agnostic device.

The wellness platform can therefore also provide integration tools to enable a wellness partner to define prompts, prompt triggers and/or timing, prompt flows, and/or prompt selection decision trees, etc. for an associated wellness plan. The wellness platform can thus provide integration tools to enable a wellness partner to customize interactions with the user through the wellness application. Block S116 can thus implement prompts, prompt selection methods, and/or prompt triggers, etc. within a particular wellness application to collect timely wellness-related information from the user and to pass the wellness-related information to the respective wellness application within the user's wellness account. However, Block S116 can function in any other way to prompt manual entry of user wellness data.

The wellness platform can further provide integration tools (e.g., an API, an SDK) to enable a wellness partner to define and/or upload user activity characterization within or specific to an associated wellness application. For example, the wellness platform can initially exclude an eating characterization algorithm, and a wellness partner that hosts a diet and nutrition program can access an SDK hosted by the wellness platform to upload an activity characterization model to characterize intermittent repetitive accelerometer data from a wristband as the user eating. In this example, another wellness partner that hosts another diet and nutrition program can similarly access the SDK to upload another activity characterization model to determine that a user is eating. Therefore, the wellness platform can enable multiple wellness partners to define and/or upload activity characterization models that are unique (or semi-unique) to an associated wellness application.

The wellness platform can further provide integration tools to enable a wellness partner to define directives, directive triggers and/or timing, directive flows, and/or directive selection decision trees, etc. for an associated wellness plan. The wellness platform can thus provide integration tools to enable a wellness partner to customize directives and/or feedback for the user. Block S140 can implement these directives, directive selection methods, and/or directive triggers, etc. within a particular wellness application to provide timely reminders and/or feedback to the user.

The wellness platform can also provide integration tools to enable a wellness partner to define one or more behavioral pattern models, and Block S140 can implement a behavioral pattern model to characterize user behavior over time (e.g., based on user activity, user-elected inputs, etc.) and subsequently elect a directive suitable for the user according to the user's characterized behavior. For example, Block S140 can implement a behavioral pattern model to characterize the user's responses to previous directives (i.e., user response trends) and subsequently apply the user response characterization to select subsequent directives for the user and/or to predict an optimal directive delivery time. The wellness platform can similarly provide integration tools (e.g., an API, an SDK) to enable a wellness partner to define one or more machine learning algorithms, and Block S140 can import user response characterizations, user trends, user inputs, user activities, etc. into a machine learning algorithm to improve and/or customize directive selection and/or generation for the user. Block S140 can also implement user-defined preferences for directive handling, such as directive timing, number of directives to push to the user within a period of time, etc., and Block S140 can implement the user-defined preferences to generate and/or select directives, and Block S150 can implement the user-defined preferences to set directive timing. However, Block S140 can function in any other way to generate a directive for the user based on a wellness program rule and environmental data, user motion data, and/or a manual user input.

In one implementation, Blocks S110, S112, S114, S116, and S120 are implemented at the native wellness program level, wherein user, environmental, and other relevant data is collected locally on the mobile computing device and/or remotely and packaged for a third-party wellness application sitting on top of the native wellness program. In this implementation, the SDK (and/or API) can define path or plug-ins for access to outputs of Blocks S110, S112, S114, S116, and S120, and each wellness application hosted by third-party wellness partner can apply the SDK to select particular outputs from these Blocks and to define responses to each within the framework of corresponding habit programs. Thus, Block S130, S140, S150, etc. can be implemented at the wellness application level, wherein a user-elected native wellness application executing on the native wellness program selectively accesses and responds to outputs of Blocks S110, S112, S114, S116, and S120 to serve deliberate and wellness application-specific directives to a user.

### 2. Second Method

As shown in FIG. 7, a second method S200 for prompting behavior change includes: receiving a first set of user activity data collected on a wearable device and on a mobile computing device during a first time period in Block S210; identifying a habit within the first time period based on the first set of user activity data in Block S220; assigning a classification to the habit in Block S230; receiving a second set of user activity data collected on the wearable device during a second time period in Block S240; based on the second set of user activity data, determining a deviation from the habit during the second time period in Block S250; generating a behavior change prompt to modify the habit based on the classification of the habit and the deviation from the habit that exceeds a threshold deviation in Block S260.∂

Generally, second method S200 functions to identify user habits and/or common behaviors from user data collected over time and to identify deviations from these habits or behaviors to power behavior insights and/or behavioral prompts to serve to the user. Like first method S110, Blocks of second method S200 can be implemented within a native wellness platform and/or within a wellness application elected by the user within the native wellness platform. Blocks of second method S200 can therefore execute directly on a mobile computing device carried by the user or remotely, such as on a remote server or computer network, in cooperation with the user's mobile computing device, as described above. Second method S200 can also execute within the behavior change engine described above—such as in conjunction with or in place of first method S100—a to deliver timely and relevant prompts to the user, such as based on a wellness application elected by the user within a native wellness platform.

### 2.1 Example Implementations

In one example implementation, Block S220 determines that the user often rides an elevator rather than taking the stairs up to his work office based on user motion and location data collected over time in Block S210, and Block S230 classifies this habit as a negative habit based on a fitness application elected by the user within the native wellness platform. In this example implementation, Block S240 can later collect user motion and location data to determine that the user took the stairs into his office and Block S250 can identify this deviation as a positive (i.e., healthful) deviation from the negative habit of taking the elevator. Block S260 can then respond to this deviation by congratulating the user for his effort in building a better fitness-related habit.

Block S250 can also calculate an “effort score” for the user's deviation away from the negative habit (or toward a positive habit), and Block S250 can respond accordingly. For example, in this example implementation, Block S220 can determine that the user has never taken the stairs up to his office (at least during a data collection period) and thus calculate a probability of <5% that the user will take the stairs on any given day. Thus, when Block S240 determines that the user takes one flight of stairs and the elevator the remainder of the distance to his office floor, Block 250 can associate a high effort score (e.g., 8/10) for the user's change in behavior. In this example, Block S250 can associate an even higher score effort (e.g., 9/10) if the user takes two (or more) flights up to his office floor. Similarly, Block S220 can determine that the user occasionally takes the stairs up to his office and thus calculates a probability of ˜40% that the user will take the stairs on any given day. Thus, when Block S240 determines that the user takes the stairs the full way up to his office floor, Block 250 can associate an moderate effort score (e.g., 6/10) for the user's behavior. Block S240 can therefore estimate the user's effort in moving toward a positive habit (or away from a negative habit) rather than simply responding to whether or not the user completed a certain action or activity.

Block S260 can thus respond accordingly, such as by serving greater amounts of praise to actions associated with higher user efforts. Block S260 can also serve directives with lower reminders of goals or updates goals in response to user actions associated with higher user efforts. In the foregoing example in which the user has not previously taken the stairs but one day takes one flight of stairs up to his office, which is associated with a high effort score, Block S260 can serve a message to the user that recites “Jim, this is a big day for you—you took the stairs! Congratulations! Let us know if you'd like us help motivate you to continue taking the stairs.” However, in the foregoing example in which the user has a 40% chance of taking the stairs does take the stairs up to his office—which is associated with a moderate effort score—Block S260 can serve a message to the user that recites “Jim, taking the stairs again—right on! Try to make it two days in a row. We'll remind you tomorrow when you're close to work.” Block S250 can therefore enable delivery of empathetic directives or prompts to the user in Block S260.

In another example implementation, Block S220 determines that the user is 70% likely to eat a leafy vegetable for lunch based on user data collected over time in Block S210, and Block S230 classifies this habit as a positive habit based on a dietary application elected by the user within the native wellness platform. In this example implementation, Block S240 can later collect additional user dietary data, and Block S250 can then determine that the user again ate a leafy vegetable for lunch and assign a low effort score to this action. Block S260 can then deliver an endorsement of the user's positive dietary action and prompt the user to further improve his diet, such as by suggesting alteration to the user's dinner or dessert habits. Alternatively, in a similar implementation, Block S220 determines that the user is 70% likely to eat a leafy vegetable for lunch, and Block S230 again classifies this habit as a positive habit. However, Block S250 can determine—from once subsequent user dietary data collected in Block S240—that the user did not eat a leafy vegetable for lunch. Block S260 can thus deliver a directive or prompt to guide the user back toward the positive habit of eating leafy vegetables for lunch. For example, Block S260 can prompt the user to turn on a positive habit reinforcement assistance program within the corresponding dietary wellness application, wherein the positive habit reinforcement assistance program includes a set of prompts or directives, prompt delivery time definitions, etc. specifically tailored to better assist the user in achieving a diet-related goal and/or enforcing a dietary habit. For example, the positive habit reinforcement assistance program can specify a higher-than normal frequency of positive habit-specific directives, and by enabling the user to opt-in to the positive habit reinforcement assistance program, second method S200 can better ensure that the user will find related prompts useful, relevant, and worth following rather than an annoyance.

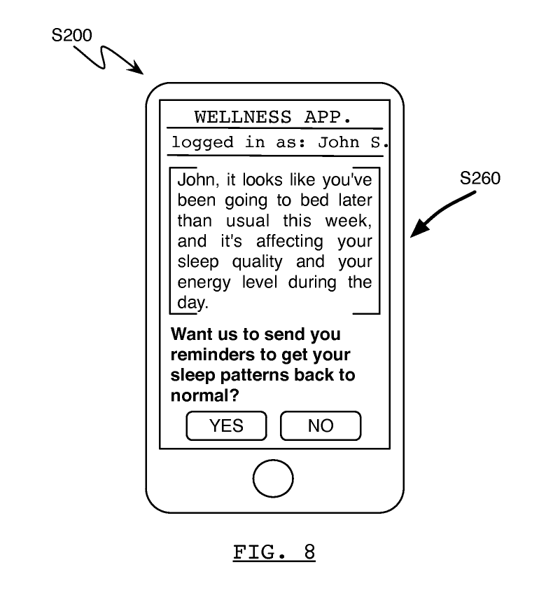

Similarly, Block S230 can classify a habit identified in Block S220 as a negative habit based on a wellness application elected by the user, and Block S250 can determine that the user repeated an action or activity corresponding to the negative habit based on new data collected in Block S240. Block S260 can then deliver a prompt to the user to guide the user away from the negative habit, such as by prompting the user to turn on a negative habit mitigating program or the positive habit reinforcement assistance program described above, such as shown in FIG. 8.

However, Blocks of second method S200 can cooperate in any other way to deliver empathetic directives or prompts to the user based on deviations from “normal” habits and behaviors of the user.

### 2.2 Data

Block S210 of second method S200 recites receiving a first set of user activity data collected on a wearable device and on a mobile computing device during a first time period. Block S240 of second method S200 similarly recites receiving a second set of user activity data collected on the wearable device during a second time period. Generally, Block S210 and S240 implement methods and techniques described above to collect user data over time. In particular, Block S210 collects data over a period of time to build a baseline image of the user, such as user action data, user activity data, environmental data, location data, etc., as described above. For example, Block S220 can implement these data to generate a timeline of user actions, user activities, environmental conditions, user locations, etc. and to identify user habits from behavioral trends within the timeline. Alternatively, Block S240 collects new user data to enable Block S250 to identify deviations from “normal” behaviors of the user, as described below.

### 2.3 Habits

Block S220 of second method S200 recites identifying a habit within the first time period based on the first set of user activity data. Generally, Block S220 implements methods and techniques applied in Block S120 described above to identify correlations between various data collected in Block S210, to extrapolate behavioral trends in the timeline, to identify environmental, location, and other triggers for various user behaviors, and to identify user habits from one or more behavioral trends within the timeline.

Block S220 can characterize the user based on a set of user habits identified in various user motion, user action, user activity, environmental, location, and/or other data collected over time in Block S210. Block S220 can then assemble these user habits output into a user habit map (shown in FIG. 7) defining a likelihood of a user action or a user response responsive to a time, a location, an ambient or environmental condition, or other condition or event. For example, the habit map can specify that the user is 70% likely to consume a breakfast on a weekday, that the user is 83% likely to consume a caffeinated beverage when within three blocks of an address between 8 AM and 9 AM on a weekday, and 65% likely to consume ice cream on a Sunday evening. In another example, the habit map can specify that the user is 81% likely to run between 3.3 and 3.6 miles on a weekday when the local temperature is above 55° F., 59% likely to run between 3.0 and 3.4 miles on a weekday when the local temperature is between 40° F. and 55° F., and 20% likely to run at all on a weekday when the local temperature is less than 40° F. In another example the habit map can specify that the user is 95% likely to miss or forget to consume a medication one day each week. The habit map can further specify that the user is likely to exhibit a 15% reduction in average energy level during a work day following restless sleep or a sleep period between five and six hours. However, Block S220 can generate any other suitable user habit definition from data collected in block S210, and Block S220 can assemble these habit definitions into the habit map in any other suitable way to qualitatively and quantitatively characterize the user.

As Blocks S210 and S240 collect additional user, environmental, location, and/or other related data over time, Block S220 can update the habit map for the user, such as to accommodate changes in the user's habits as the user adopts new or modifies existing habits throughout engagement of habit programs within wellness applications elected by the user within the native wellness platform. For example, Block S220 can aggregate user, environmental, location, and other data over time into a timeline of events, assign different weights to various events based on a time from current, and extrapolate user behavioral trends (i.e., habits) from the timeline based on weights of the various events. In this example, Block S220 can assign greater weight to recent events and lesser weight to events that occurred significantly in the past, such as a week or month prior to the current date. However, Block S220 can function in any other way to generate and update a user habit map over time to characterize the user. Block S220 can also identify any one or more user habits and can pass this habit(s) to subsequent Blocks of second method S200 in any other suitable form or format.

In one implementation, Blocks S210 and S220 can be implemented by the native wellness platform—that is, at the native wellness platform level—and Block S220 can serve the habit map to a wellness application elected by the user, which implements Block S230, as described below.

### 2.4 Habit Classification

Block S230 of second method S200 recites assigning a classification to the habit. Generally, Block S230 functions to classify a habit received from Block S220 as a positive habit or a negative habit (or a neutral habit).

In one implementation described above, Block S220 executes to the native wellness platform level to output a user habit map. Block S230 then executes within a user elected wellness application on top of the native wellness platform to access the user habit map. In particular, the wellness application defines which types of habits are relevant to the wellness application, and Block S230 characterizes select relevant habits within the habit map. For example, for Block S230 implemented within a dietary wellness application, Block S230 can characterize habits related to food and drink consumption-related habits, such as when the user is likely to eat at a particular time, what the user is likely to drink when near a particular location, and/or a meal that the user is likely to skip when a particular event occurs.

S230 can therefore access select habits from a habit map specific to a user and assign a positive or negative attribute to each select habit. For example, the habit map can specify that the user is 77% likely to complete a thirty-minute yoga session on a weekday morning, and Block S230 can characterize this habit as a positive habit. In another example, the habit map can specify that the user is 83% likely to eat a snack over 300 calories after 9:30 PM when the user returns to a home location after 8 PM, and Block S230 can characterize this habit as a negative habit. However, Block S230 can characterize any other user habit identified in Block S220 in any other suitable way.

Furthermore, an implementation of Block S230 in a first wellness application can characterize a user habit differently than another implementation of Block S230 in a second wellness application.

### 2.5 Habit Deviation

Block S250 of second method S200 recites, based on the second set of user activity data, determining a deviation from the habit during the second time period. Generally, as Block S240 collects new user action and/or user activity data, Block S250 determines how closely the new user action and/or user activity data “match” a corresponding habit identified in Block S220 (e.g., a user habit specified in the user habit map). In particular, Block S250 can select a habit related to the new user action data based on a related time (e.g., time of day, day of week) and/or environmental, location, or other contextual data relating to the new user action.

For various types of user actions or activities, Block S250 can generate a qualitative and/or qualitative metric of the user's deviation from a corresponding habit, such as whether or not the user completed an anticipated action (e.g., if the user did or did not exercise), a change in the start or end time of an anticipated action (e.g., if the user exercised earlier or later in a day or in a week than anticipated), a change in duration an anticipated action (e.g., if the user exercised for a more or less time than anticipated), and/or a change in the magnitude or degree of an anticipated action (e.g., how hard the user exercised or how fast the user ran relative to an anticipated effort or speed). However, Block S250 can output a metric for deviation of any other characteristic of a new user action from a corresponding characteristic of a corresponding user habit.

In one implementation, Block S220 generates the user habit map that specifies various user habits characterized by any one or more of day(s) of the week, time of day, user location, ambient temperature, local weather condition, previous user action or activity, etc., and Block S240 collects user action data and related time, date, location, temperature, and weather data. Block S250 then filters habits in the user habit map based on any one or more of these data collected in Block s240 to select a particular user habit related to the new user action. For example, the habit map can specify a diet-, fitness-, and sleep-related (or affected) habit for one or more of a morning, an early afternoon, a late afternoon, an evening, and a night time period, and Block S220 can assign specific locations or location ranges, ambient temperature, and/or weather conditions to at least some of these habits. In this example, Block S250 can thus select a particular habit in the set of user habits accordingly.

Once a related user habit is selected, Block S250 can identify a deviation of the new user action from the habit. For example, if Block S240 identifies the current day as a weekday and the daily average ambient air temperature for the user's locations is/was 68° F., Block S250 can select a user habit specifying that the user is 81% likely to run between 3.3 and 3.6 miles on a weekday when the local temperature is above 55° F., which Block S230 can classify as a positive habit. In this example, if Block S240 determines that the user just completed a 3.8 mile run, Block S250 can correlate this new user action with a positive deviation toward the positive habit of running, which the user was 81% likely to complete on this day. In this example, Block S250 can further correlate this new user action with a level of user effort, such as by associating the 3.8-mile run with 16% more user effort over a typical 3.3- to 3.6-mile run. However, in a similar example, if Block S240 determines that the user completed only a 2.7 mile run, Block S250 can correlate this new user action with a negative deviation from the positive habit of running. In this example, Block S250 can further associate the 2.7-mile run with 28% less user effort over the typical 3.3- to 3.6-mile run. Alternatively, Block S250 can correlate completion of the 2.7-mile run with an increase in user effort if the user has already completed seven runs between 3.3 and 3.6 miles within the previous nine weekdays in addition to the latest run by the user (i.e., the user just completed an eight run over a two-week period despite a previous average of only seven runs per two-week period).

In another example, if Block S240 receives a new user action specifying consumption of a leafy vegetable during a lunch period, Block S250 can select a user meal consumption habit specifying that the user is 66% likely to consume a leafy vegetable during lunch, which Block S230 can classify as a positive habit. In this example, Block S250 can correlate this new user meal consumption with a positive deviation toward the positive habit of eating leafy vegetables, which the user was 66% likely to perform on a given day, and Block S250 can further associate this new user meal consumption with a 14% increase weekly user effort, since the user has already consumed a leafy vegetable for five consecutive days.

Block S250 can similarly determine a deviation and calculate a corresponding change in user effort for various other types of user actions, such as consuming medication, sleeping, preparing to sleep, waking from sleeping, studying, working, reducing sedentary time, etc. Furthermore, for the user habit map—output in Block S220—that specified multiple habits, Block S250 can calculate a deviation and/or a change in user effort for all or a subset of the specified habits as new relevant user data is collected in Block S240. For example, Block S250 can determine a deviation from each habit in the user habit map during the second time and thus generate a dossier of the habits and corresponding deviations. Block S250 can subsequently pass a singular habit deviation, a set of habit deviations, and/or the dossier to Block S260 to inform selection and delivery of a prompt to the user. For example, Block S250 can execute within the native wellness platform to manipulate data collected and generated in Blocks S210, S220, and S240 into habit deviations and to package these habit deviations into a format accessible by Block S260—executing within a user-elected wellness application running on top of the native wellness program—to deliver a behavior change prompt to the user. However, Block S250 can function in any other way to determine user deviation from an identified user habit.

### 2.5 Prompts

Block S260 of second method S200 recites generating a behavior change prompt to modify the habit based on the classification of the habit and the deviation from the habit that exceeds a threshold deviation. Generally, Block S260 functions to apply a user habit deviation output in Block S250 to respond to a new user action detected in Block S240. In particular, Block S260 can select (or generate) a prompt to recognize and reinforce positive user deviation toward a positive habit or negative user deviation from a negative habit. Block S260 can similarly select a prompt to inform the user of and provide guidance to mitigate positive user deviation toward a negative habit or negative user deviation from a positive habit.

Like Block S230, Block S260 can be implemented within a wellness application elected by the user within the native wellness program to serve wellness application-specific prompts to the user. For example, Blocks S230 and S260—executing within a particular wellness application—can cooperate to receive a user habit map from Block S220, to select a particular habit within the user habit map as related to the particular wellness application, define the particular habit as a positive or negative habit, and to serve a behavior change prompt to the user based on a habit deviation (from Block S250) and the determined characteristic of the particular habit.

In one implementation, Block S260 generates the behavior change prompt in response to a detected deviation of a magnitude of the user action exceeding the magnitude of the action defining the habit by a threshold magnitude. For example, as described above, Block S250 can correlate a change in the amount and/or distance that a user runs with a change in user effort during exercise, and Block S260 can serve a prompt to the user congratulating him on his extra effort. As described above, Block S250 can also determine a change in timing of a user habit (e.g., the user goes to bed earlier than normal), and Block S260 can serve a prompt to the user acknowledging the change in timing of the user's habit (e.g., “Congratulations, you've taken a step toward better, longer sleep and a more productive work day tomorrow”). However, Block S260 can respond to any other type of user habit deviations identified and output in Block S250.

Block S260 can respond to only user habit deviations that exceed threshold deviations. For example, Block 260 can respond to only increases or decreases in determined user effort that exceed 10%, (or other static proportion), which may account for errors and/or variations in data collection and manipulation in the previous Blocks. Block S260 can also set thresholds for different habit deviations independently, such as an effort change of more than 10% for fitness-related actions, a change in time of twenty minutes from when the user commonly initiates a major daily activity (e.g., eating breakfast, lunch, dinner or going to bed), an action duration that changes by more than 5% (e.g., a length of time during the day that the user is sedentary), etc.

Block S260 can function like Block S140 described above to select a directive for the user from a set of available directives associated within the corresponding wellness application. Alternatively, Block S260 can assemble user habit and/or deviation data into a custom prompt. For example, Block S260 can serve to the user a prompt specifying that the user ate more vegetable this week than in past weeks, ran fewer times this week than last week, slept thirty minutes longer this past night than on five previous nights, ran with 9% greater intensity today than this day last week, etc. Block S260 can thus generate a prompt provoke the user to reflect on a change in a personal behavior and how this change affects the way the user feels physically or mentally, his energy level, his ability to focus, etc. For example, Block S260 can generate a prompt that recites, “John, you ran 4.2 miles more this week than you've average for the last two months. Are you noticing an increase in your energy level?”

As described above, if Block S250 determines that the user is deviating away from a positive habit, Block S260 can also prompt the user to enable a positive habit reinforcement assistance program within the wellness application, such as shown in FIG. 8. Similarly, if Block S250 determines that the user is deviating toward a negative habit, Block S260 can also prompt the user to enable a positive habit reinforcement assistance program within the wellness application. For example, if Block S250 determines that the user is consuming more sweets than usual, thereby deviating from a dietary habit program within a wellness application, Block S260 can prompt the user to opt into a positive habit reinforcement assistance program that delivers a higher volume of timely notifications to the user to remind the user to avoid sweets during time periods and/or while in certain locations in which the user commonly consumes sweets, to remind the user to bring a healthy snack before leaving his home or office, etc.

In another implementation, Block S260 prompts the user to confirm that a positive habit deviation toward a positive habit (or a negative habit deviation away from a negative habit) detected in Block S250 was, in fact, intentional and therefore associated with some degree of effort. In particular, Block S260 can prompt the user to provide deviation feedback to confirm or invalidate that the user deviated from a habit out of intent to improve his health. For example, if the Block S250 determines that the user ran 1.2 miles farther than is typical for the user, Block S260 can inform the user of the deviation and ask the user if he ran the extra distance because he “felt like it,” because he unintentionally took a wrong turn that made his run longer, or because he was actively trying to improve his health, as shown in FIG. 7. In this example, Block S260 can pre-populate a textual list of responses for the user and display these responses on the mobile computing device or deliver the prompt to the user audible through an intelligent personal assistant with natural language user interface executing on the user's mobile computing device. Block S260 can thus receive a text-selection, textual input, or oral input from the user and apply this feedback to the deviation to define a cause or impetus for the deviation. In particular, Block S260 can apply user feedback to the habit deviation to improve a degree of confidence that the habit deviation was or was not the result of user effort to make a health-related change. For deviations that the user confirms as intentional actions to improve his health (and/or wellness), Block S260 can thus deliver an additional prompt to the user to congratulate him for the action, reinforce the user's action, and/or provide additional support to perpetuate the positive action.

In the foregoing implementation, Block S260 can similarly prompt the user to confirm that a negative habit deviation away from a positive habit (or a positive habit deviation toward a negative habit) detected in Block S250 was, in fact, intentional and therefore associated with a “slip,” some degree of reduced effect, loss of motivation, etc. for the user. Block S260 can again apply the user feedback to the habit deviation to improve a degree of confidence that the habit deviation was or was not the result of a “slip,” some degree of reduced effect, loss of motivation, etc. and respond accordingly, such as by presenting a habit reinforcement assistance program or a negative habit mitigating program, as described above. However, Block S260 can implement any other method or technique to confirm that a user habit deviation was intention and to respond accordingly.

Block S260 can further implement methods or techniques applied in Block S150 above to deliver the behavior change prompt to the user, such as by displaying the prompt as a notification on a smartphone carried by the user. However, Block S260 can function in any other way to generate and/or deliver a behavior change prompt to the user.

As shown in FIG. 7, Block S260 can also prompt the user to respond to the habit deviation, such as shown in FIG. 7. Block S260 can then store the user's response for future use and/or pass the user's response back into Block S220 to support identification of factors and variables that lead to deviations from the user's habits.

The systems and methods of the preferred embodiment can be embodied and/or implemented at least in part as a machine configured to receive a computer-readable medium storing computer-readable instructions. The instructions are preferably executed by computer-executable components preferably integrated with the application, applet, host, server, network, website, communication service, communication interface, hardware/firmware/software elements of a user computer or mobile device, wristband, smartphone, or any suitable combination thereof. Other systems and methods of the preferred embodiment can be embodied and/or implemented at least in part as a machine configured to receive a computer-readable medium storing computer-readable instructions. The instructions are preferably executed by computer-executable components preferably integrated by computer-executable components preferably integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component is preferably a processor but any suitable dedicated hardware device can (alternatively or additionally) execute the instructions.

As a person skilled in the art will recognize from the previous detailed description and from the figures and claims, modifications and changes can be made to the preferred embodiments of the invention without departing from the scope of this invention as defined in the following claims.

We claim:

1. A method for prompting behavior change, comprising:
receiving a first set of user activity data collected on a wearable device and on a mobile computing device during a first time period;
identifying a habit within the first time period based on the first set of user activity data;
assigning a classification to the habit;
receiving a second set of user activity data collected on the wearable device during a second time period;
based on the second set of user activity data, determining a deviation from the habit during the second time period; and
generating a behavior change prompt to modify the habit based on the classification of the habit and the deviation from the habit that exceeds a threshold deviation.

2. The method of claim 1, wherein assigning the classification to the habit comprises defining the habit as a positive habit within a wellness application elected by the user, wherein determining the deviation from the habit comprises determining a deviation away from the positive habit, and wherein generating the behavior change prompt comprises prompting the user to enable a positive habit reinforcement assistance program within the wellness application based on the deviation away from the positive habit.

3. The method of claim 1, wherein assigning the classification to the habit comprises defining the habit as a negative habit within a wellness application elected by the user, wherein determining the deviation from the habit comprises determining a deviation toward the negative habit, and wherein generating the behavior change prompt comprises prompting the user to enable a positive habit reinforcement assistance program within the wellness application based on the deviation toward the negative habit.

4. The method of claim 1, wherein assigning the classification to the habit comprises defining the habit as a positive habit within a wellness application elected by the user, wherein determining the deviation from the habit comprises determining a deviation toward the positive habit, and wherein generating the behavior change prompt comprises generating a endorsement based on the deviation toward the positive habit.

5. The method of claim 4, wherein determining the deviation toward the positive habit comprises correlating a magnitude of deviation toward the positive habit with a magnitude of user effort, and wherein generating the behavior change prompt comprises generating the endorsement based on the magnitude of user effort.

6. The method of claim 1, wherein assigning the classification to the habit comprises defining the habit as a negative habit within a wellness application elected by the user, wherein determining the deviation from the habit comprises determining a deviation away from the negative habit, and wherein generating the behavior change prompt comprises generating a summary of the second set of user activity data and prompting the user to reflect on the summary and the deviation away from the negative habit.

7. The method of claim 1, wherein identifying the habit comprises identifying a set of habits within the first time period based on the first set of user activity data, the set of habits comprising the habit, wherein determining the deviation from the habit comprises determining a deviation from each habit in the set of habits during the second time and generating a dossier of the deviations and the habits in the set of habits for the second time period, and wherein generating the behavior change prompt comprises generating the behavior change prompt corresponding to the habit and the deviation selected from the dossier by a wellness application elected by the user.

8. The method of claim 1, wherein determining the deviation from the habit during the second time period comprises determining a deviation of a magnitude of a user action during the second time period from a magnitude of an action defining the habit, wherein generating the behavior change prompt comprises generating the behavior change prompt in response to the deviation of the magnitude of the user action exceeding the magnitude of the action defining the habit by a threshold magnitude.

9. The method of claim 1, wherein identifying the habit comprises generating a timelines of identified user actions from the first set of activity data and identifying a pattern of identified user actions within the timeline, the pattern defining the habit.

10. The method of claim 9, wherein determining the deviation from the habit during the second time period comprises determining a deviation of a timing a user action during the second time period from a timing of the pattern, wherein generating the behavior change prompt comprises generating the behavior change prompt in response to the deviation of the timing of the user action exceeding the timing of the pattern by a threshold time value.

11. The method of claim 1, further comprising assigning a first weight to the first set of user activity data, assigning a second weight to the second set of user activity data, and updating the habit with the second set of user activity data according to the first weight and the second weight, the second weight exceeding the first weight.

12. The method of claim 1, wherein generating the behavior change prompt comprises prompting the user to confirm that the deviation from the habit was motivated by intent to improve the health of the user.

13. A method for delivering behavior change directives to a user, comprising:
receiving a first set of user motion data from a wearable device;
receiving a second set of user motion data from a mobile computing device;
calculating a confidence score for a determined user activity based on a comparison between the first set of user motion data and the second set of user motion data;
selecting a habit program defined within a wellness application elected by the user; and
selecting a directive, from a set of directives associated with the habit program, based on the determined user activity and the confidence score for the determined user activity.

14. The method of claim 13, wherein receiving the second set of user motion data comprises further receiving location data from the mobile computing device, and wherein calculating a confidence score comprises calculating a confidence score further based on the location data and an activity associated with the location data.

15. The method of claim 13, further comprising retrieving environmental data from a remote database, wherein selecting the directive comprises selecting the directive based on a weather forecast specified in the environmental data.

16. The method of claim 13, further comprising prompting manual entry of user wellness data into the mobile computing device, wherein selecting the directive comprises selecting the directive in response to receiving an entry from the user and further based on the entry from the user.

17. The method of claim 13, wherein selecting the directive comprises preselecting a first directive from the set of directives based on an anticipated action of the user and deselecting the first directive and selecting an alternative directive from the set of directives in response to the determined user activity and the confidence score for the determined user activity exceeding a threshold confidence score.

18. The method of claim 13, wherein selecting the habit program comprises selecting a diet-related habit program defined within a diet-related wellness application, and wherein selecting the directive comprises selecting a diet-related directive to reinforce a diet-related habit.

19. The method of claim 13, further comprising
identifying repetition of the determined user activity as a user routine within a time period corresponding to the first set of user motion data,
correlating the routine with a habit specified in the habit program,
based on the user routine, determining a deviation from the habit during the time period,
for a deviation less than a threshold deviation, predicting adoption of the habit by the user, and
in response to adoption of the habit by the user, selecting a subsequent habit program defined within the wellness application.

20. The method of claim 13, wherein calculating the confidence score comprises verifying a user activity identified on and received from the wearable device based on the second set of user motion data.

21. The method of claim 13, further comprising displaying the directive on a display of the mobile computing device.
